(19) United States
(12) Patent Application Publication
(10) Pub. No.: US 2015/0174605 A1
(43) Pub. Date: Jun. 25, 2015

(54) FILM FORMING DEVICE AND FILM FORMING METHOD

(71) Applicants: BROTHER KOGYO KABUSHIKI KAISHA, Nagoya-shi (JP); NATIONAL UNIVERSITY CORPORATION NAGOYA UNIVERSITY, Nagoya-shi (JP)

(72) Inventors: Kentaro SHINODA, Nagoya-shi (JP); Hideki KANADA, Toyohashi-shi (JP); Kazunari TAKI, Nagoya-shi (JP); Hiroyuki KOUSAKA, Nagoya-shi (JP); Yasuyuki TAKAOKA, Nagoya-shi (JP); Takashi OKAMOTO, Nagoya-shi (JP)

(73) Assignees: NATIONAL UNIVERSITY CORPORATION NAGOYA UNIVERSITY, Nagoya-shi (JP); BROTHER KOGYO KABUSHIKI KAISHA, Nagoya-shi (JP)

(21) Appl. No.: 14/638,170

(22) Filed: Mar. 4, 2015

Related U.S. Application Data
(63) Continuation-in-part of application No. PCT/JP2013/073996, filed on Sep. 5, 2013.

(30) Foreign Application Priority Data
Sep. 7, 2012 (JP) 2012-197874

(51) Int. Cl. B05D 1/00; B05C 5/00

(52) U.S. Cl. CPC B05D 1/007; B05C 5/001

(57) ABSTRACT

A film forming device includes: a microwave supplying unit configured to supply microwave pulses to generate plasma along a processing surface of a workpiece material; an applying unit configured to apply negative bias voltage pulses to spread a sheath layer along the processing surface of the workpiece material, and a control unit configured to control an applying timing of the negative bias voltage pulses and a supplying timing of the microwave pulses, wherein the control unit is configured to control the applying timing of the negative bias voltage pulses and the supplying timing of the microwave pulses so that a ratio of an applying time period of one negative bias voltage pulse in a supplying time period of one microwave pulse to the supplying time period of one microwave pulse is equal to or greater than 0.9.

### CROSS-REFERENCE TO RELATED APPLICATION

This application claims priority from Japanese Patent Application No. 2012-197874 filed on Sep. 7, 2012 and PCT Application No. PCT/JP13/073996 filed on Sep. 5, 2013, the entire subject matter of which is incorporated herein by reference.

### TECHNICAL FIELD

This disclosure relates to a film forming device, a film forming method and a film forming program for forming a hard film such as DLC on a surface of a workpiece material having conductivity such as a steel material at high speed by using plasma.

### BACKGROUND

A technology of forming a DLC (Diamond-Like Carbon) film on a surface of a workpiece material having conductivity such as a steel material has been known. In such technology, a plasma generation device is configured to supply microwaves towards a workpiece material in a processing vessel through a quartz window to generate plasma at a workpiece area side from the quartz window and then to generate a sheath layer at a boundary between the plasma and the workpiece material. The plasma generation device is configured to apply a negative bias voltage to the workpiece material during the supplying of the microwaves. As a result, the sheath layer is formed along the surface of the workpiece material and the formed sheath layer is spread. The supplied microwaves propagate along the sheath layer and the plasma extends. As a result, a source gas is decomposed by the plasma and a DLC film is formed on the surface of the workpiece material.

### SUMMARY

A film forming device according to one aspect of this disclosure, comprising: a gas supplying unit configured to supply a source gas having carbon and hydrogen and an inert gas to a processing vessel provided with a workpiece material having conductivity; a microwave supplying unit configured to supply microwave pulses to generate plasma along a processing surface of the workpiece material; an applying unit configured to apply negative bias voltage pulses to the workpiece material in the processing vessel to spread a sheath layer along the processing surface of the workpiece material, and a control unit configured to control an applying timing of the negative bias voltage pulses of the applying unit and a supplying timing of the microwave pulses of the microwave supplying unit, wherein the control unit is configured to control the applying timing of the negative bias voltage pulses and the supplying timing of the microwave pulses so that a ratio of an applying time period of one negative bias voltage pulse in a supplying time period of one microwave pulse to the supplying time period of one microwave pulse is equal to or greater than 0.9.

A film forming method according to one aspect of this disclosure, comprising: supplying a source gas having carbon and hydrogen and an inert gas to a processing vessel provided with a workpiece material having conductivity; supplying microwave pulses to generate plasma along a processing surface of the workpiece material; applying negative bias voltage pulses to the workpiece material in the processing vessel to spread a sheath layer along the processing surface of the workpiece material, and controlling an applying timing of the negative bias voltage pulses and a supplying timing of the microwave pulses, wherein the controlling controls the applying timing of the negative bias voltage pulses and the supplying timing of the microwave pulses so that a ratio of an applying time period of one negative bias voltage pulse in a supplying time period of one microwave pulse to the supplying time period of one microwave pulse is equal to or greater than 0.9.

A non-transitory computer-readable medium according to another aspect of this disclosure has instructions to control a computer in a film forming device comprising a gas supplying unit configured to supply a source gas having carbon and hydrogen and an inert gas to a processing vessel provided with a workpiece material having conductivity; a microwave supplying unit configured to supply microwave pulses to generate plasma along a processing surface of the workpiece material, and an applying unit configured to apply negative bias voltage pulses to spread a sheath layer along the processing surface of the workpiece material to the workpiece material supported in the processing vessel, the computer, when executing the instructions, causing the film forming device to execute: controlling an applying timing of one negative bias voltage pulse of the applying unit and a supplying timing of one microwave pulse of the microwave supplying unit, wherein the computer controls the applying timing of the negative bias voltage pulses and the supplying timing of the microwave pulses so that a ratio of an applying time period of one negative bias voltage pulse in a supplying time period of one microwave pulse to the supplying time period of one microwave pulse is equal to or greater than 0.9.

### BRIEF DESCRIPTION OF THE DRAWINGS

FIG. 1 illustrates a schematic configuration of a film forming device;

FIG. 2 is a block diagram showing an electrical configuration of the film forming device 100;

FIG. 3 shows a control table;

FIG. 4 is a pictorial view of a waveform of microwave pulses and a waveform of negative bias voltage pulses;

FIG. 5 shows a experiment result;

FIG. 6 shows film forming conditions of a test;

FIG. 7 illustrates applied states when microwave pulses and negative bias voltage pluses are applied;

FIG. 8 illustrates applied states when microwave pulses, negative bias voltage pulses and positive bias voltage pulses are applied;

FIG. 9 is a flowchart showing film formation processing; and

FIG. 10 shows a change in maximum hardness over time after the microwave pulses are applied until the negative bias voltage pulses are applied.

### DETAILED DESCRIPTION

In the background art, as an example of the microwave supply and negative bias voltage applying, it is considered that the workpiece material is disposed in the vicinity of a microwave supplying unit and supported to protrude from the microwave supplying unit. Then, microwave pulses are supplied from one end of the workpiece material and negative bias voltage pulses are applied from the other end thereof. In order to suppress a damage of the workpiece material due to arcing, it is considered that the negative bias voltage is pulsed and an applying time period of the negative bias voltage pulse is set to be shorter than a supplying time period of the microwave pulses. That is, a ratio of the applying time period of the negative bias voltage pulse to the supplying time period of one microwave pulse is set to be short.

However, a side of the DLC film to which the microwave pulses are supplied, i.e., the film adjacent to the quartz window has the lowest hardness, and the film opposite to the quartz window has the highest hardness. That is, the DLC film has a problem that hardness distribution has a spreading shape.

This disclosure is to provide a film forming device, a film forming method and a film forming program for reducing spreading of a hardness distribution in a film.

Hereinafter, an illustrative embodiment of this disclosure will be described. A film forming device 100 has a processing vessel 1, a vacuum pump 2, a gas supplying unit 3 and a control unit 4. The processing vessel 1 is a processing vessel provided with an air-tight structure. The vacuum pump 2 is a pump capable of evacuating an inside of the processing vessel 1. In the processing vessel 1, a workpiece material M having conductivity, which is a film formation target, is supported by a jig 5. The workpiece material M is not particularly limited inasmuch as it has conductivity. In this illustrative embodiment, low-temperature tempered steel is used. Here, the low-temperature tempered steel is a material such as JIS G4051 (carbon steel material for machine structural), G4401 (carbon tool steel), G44-4 (alloy tool steel), maraging steel material and the like. In addition to the low-temperature tempered steel, a ceramic or resin material having a conductive material coated thereon may be used as the workpiece material.

The gas supplying unit 3 is configured to supply a source gas for film formation and an inert gas into the processing vessel 1. Specifically, the inert gas such as He, Ne, Ar, Kr or Xe and the source gas such as CH₄, C₂H₂ or TMS (tetramethylsilane) are supplied. In this illustrative embodiment, the workpiece material M is formed with a DLC film by the source gas of CH₄ and TMS. Also, flow rates and a pressure of the source gas and inert gas supplied from the gas supplying unit 3 may be controlled by a CPU 20 (as one example of a processor), which will be described later, or the flow rates and the pressure of the source gas and inert gas may be controlled by an operator. The source gas such as CH₄, C₂H₂ and TMS (tetramethylsilane) is an example of a compound having carbon and hydrogen of this disclosure. The source gas may be a gas including a compound having a CH bonding such as alkine, alkene, alkane, aromatic compound and the like or a compound including carbon. H₂ may be included in the source gas.

Plasma for performing DLC film formation processing for the workpiece material M held in the processing vessel 1 is generated. The plasma is generated by a microwave power source 6, a microwave pulse controller 7, a negative voltage power source 8 and a negative voltage pulse controller 9. In this illustrative embodiment, it is described that surface wave excited plasma is generated by a known method of generating surface wave excited plasma (cf. disclosed in Japanese Patent Application Publication No. 2004-47207A). Hereinafter, an MVP (Microwave Voltage coupled Plasma) method, which is an example of the method of generating surface wave excited plasma, is described.

The microwave pulse controller 7 is configured to oscillate a pulse signal, in response to an instruction of the control unit 4. The microwave pulse controller 7 is configured to supply the generated pulse signal to the microwave power source 6. The microwave power source 6 is configured to generate microwave pulses, in response to the pulse signal from the microwave pulse controller 7. In this illustrative embodiment, a frequency of the microwave is 2.45 GHz. The generated microwave pulses are supplied to a processing surface of the workpiece material M via a microwave transmitting window 10. The microwave transmitting window 10 is composed of a dielectric substance enabling the microwave to transmit therethrough, such as quartz. By the microwave pulses supplied to the surface of the workpiece material M, the plasma is generated in the vicinity of the microwave transmitting window 10. The workpiece material M has a rod shape, for example, and one end thereof is disposed in close to the microwave transmitting window 10. The other end of the workpiece material M is disposed to protrude from the microwave transmitting window 10 towards an inside of the processing vessel 1. An electrode for applying a negative bias voltage pulse is connected to the workpiece material M.

The negative voltage power source 8 is configured to supply a negative bias voltage to the negative voltage pulse controller 9, in response to an instruction from the control unit 4. The negative voltage pulse controller 9 is configured to pulse the negative bias voltage supplied from the negative voltage power source 8. The pulsing processing is that the microwave pulse controller 7 controls a duty ratio of the negative bias voltage pulses, in response to the instruction from the control unit 4. The negative bias voltage pulse, which is a pulsed negative bias voltage depending on the duty ratio, is applied to the workpiece material M held in the processing vessel 1. That is, when the workpiece material M is a metal-based material or even when the workpiece material is ceramic or resin having a conductive material coated thereon, the negative bias voltage pulses are applied to an entire area of at least the processing surface of the workpiece material M.

As described in detail later, the generated microwave pulses and at least a part of the negative bias voltage pulses are controlled to be applied at the same time, so that surface wave excited plasma is generated. The frequency of the microwave is not limited to 2.45 GHz, and it may be a frequency of 0.3 GHz to 50 GHz. The negative voltage power source 8 and the negative voltage pulse controller 9 are examples of the applying unit of this disclosure. The microwave power source 6, the microwave pulse controller 7 and the microwave transmitting window 10 are examples of the microwave supplying unit of this disclosure. In the meantime, although the film forming device 100 has the negative voltage power source 8 and the negative voltage pulse controller 9, it may also have a positive voltage power source and a positive voltage pulse controller.

<Description of Surface Wave Excited Plasma>

In general, when generating the surface wave excited plasma, the microwaves are supplied along an boundary between the plasma having a predetermined electron (ion) density or higher and a dielectric substance contacting the plasma. The supplied microwaves are propagated as surface waves at a state where the energy of electromagnetic waves is concentrated on the boundary. As a result, the plasma contacting the boundary is excited by the surface waves of a high energy density and is further amplified. Thereby, the high density plasma is generated and kept. At this time, when the dielectric substance is replaced with a conductive material, the conductive material does not function as a waveguide of the surface waves, so that the propagation of the favorable surface waves and the excitation of the plasma cannot be made.

In the meantime, a charged particle layer having an essential single polarity, i.e., a so-called sheath layer is formed in the vicinity of an object contacting the plasma. When the object is a workpiece material having conductivity to which the negative bias voltage has been applied, the sheath layer is a layer having a low electron density, i.e., a layer that has a positive polarity and an dielectric constant ∈ nearly equal to 1 at a frequency band of the microwaves. For this reason, when an absolute value of the negative bias voltage to be applied is set to be higher than an absolute value of −100V, for example, a thickness of the sheath layer can be thickened. That is, the sheath layer is spread. The sheath layer functions as a dielectric substance enabling the surface waves to propagate along the boundary between the plasma and the object contacting the plasma. Therefore, when the microwaves are supplied from the microwave transmitting window 10 arranged to be close to one end of the workpiece material M and the negative bias voltage is applied to the workpiece material M, the microwaves propagates as the surface waves along the boundary between the sheath layer and the plasma. As a result, the high density excited plasma based on the surface waves is generated along the surface of the workpiece material M. The high density excited plasma is the above-described surface wave excited plasma.

The electron density of the high density plasma resulting from the surface wave excitation in the vicinity of the surface of the workpiece material reaches 10¹¹ to 10¹² CM⁻³. When forming the DLC film by a plasma CVD using the MVP method, a film formation speed of 10 to 100 μm/hr, which is higher by single-digit or double-digit, as compared to a case where the DLC film is formed by a plasma CVD of the typical negative bias voltage energy, is obtained. As a result, a film formation time period of the plasma CVD by the MVP method is 1/10 to 1/100 of a film formation time period of the typical plasma CVD.

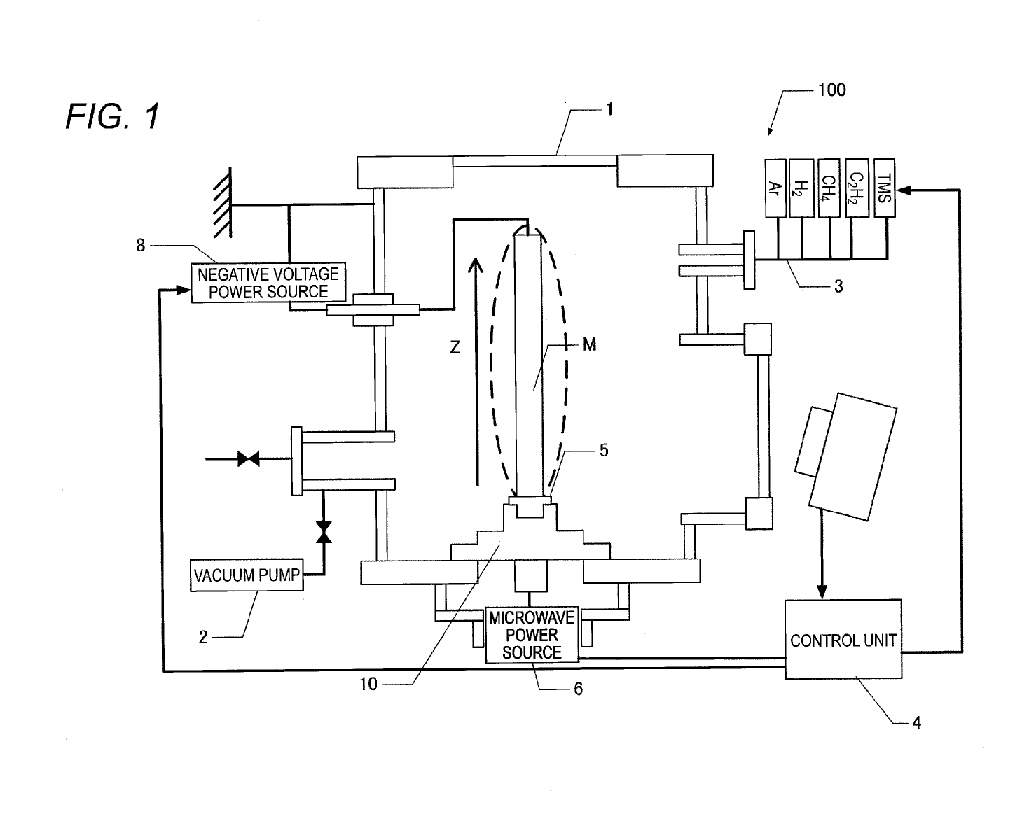

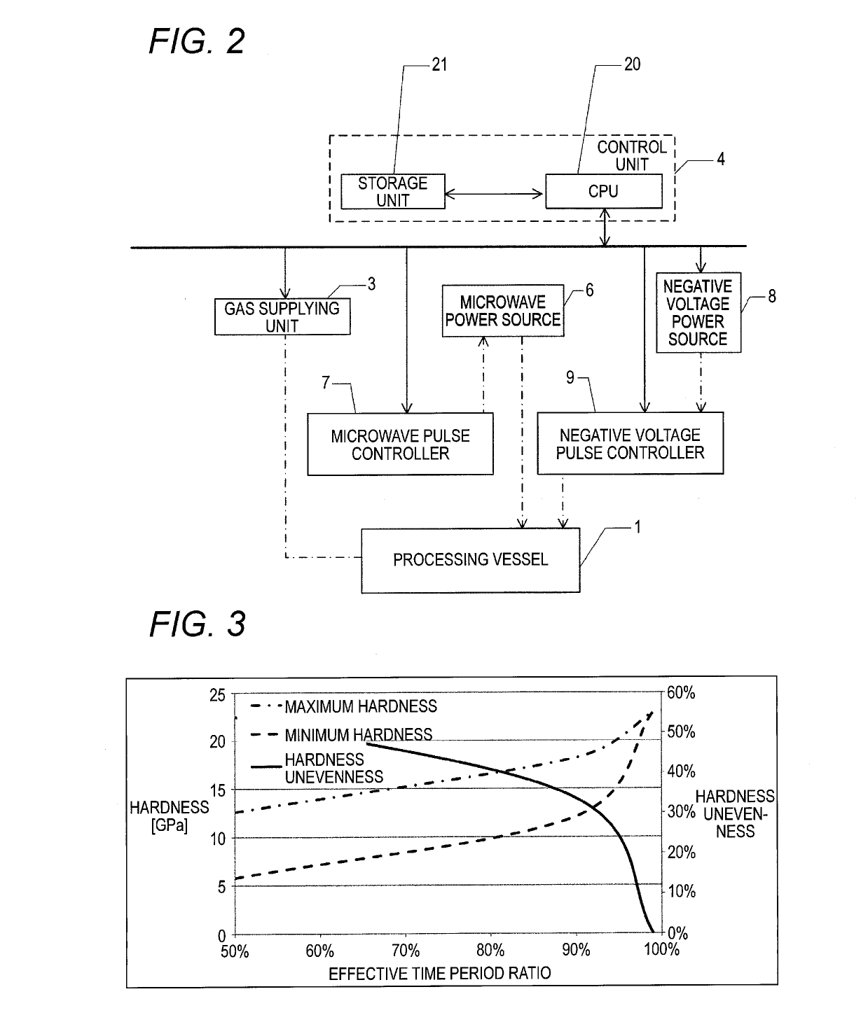

Returning to FIG. 1 or FIG. 2, the film forming device 100 is described. The control unit 4 is configured to output control signals to the negative voltage power source 8, the microwave pulse controller 7 and the negative voltage pulse controller 9, thereby controlling applied power. Although described later, the control unit 4 is configured to output the control signals to the negative voltage power source 8, the microwave pulse controller 7 and the negative voltage pulse controller 9, thereby controlling an applying timing of the negative bias voltage pulses of the negative voltage pulse controller 9 and a supplying timing of the microwave pulses of the microwave power source 6. The control unit 4 is configured to output a flow rate control signal to the gas supplying unit 3, thereby controlling supplies of the source gas and inert gas.

The control unit 4 has a CPU 20 and a storage unit 21 and is configured by a computer. The CPU 20 is configured to temporarily store a variety of information in a volatile storage device (not shown) such as a RAM and to execute a program for film forming processing, which will be described later. The program for film forming processing may be read from a non-transitory storage medium such as a CD-ROM, a DVD-ROM and the like by a driver (not shown) or may be downloaded from a network (not shown) such as Internet. The storage unit 21 is a non-transitory and non-volatile storage device such as a ROM and an HDD, and is configured to store therein a film forming program and a control table shown in FIG. 3. The non-transitory and non-volatile storage device is a storage medium capable of storing information regardless of a storing period of the information. The non-transitory and non-volatile storage device may not include transitory information such a signal being transmitted. In the control table, a ratio of an applying time period, maximum hardness, minimum hardness and hardness unevenness are stored with being associated. The ratio of an applying time period represents a ratio of one negative bias voltage pulse in a supplying time period of one microwave pulse to the supplying time period of one microwave pulse.

In FIG. 3, the ratio of the applying time period is shown as an effective time period ratio.

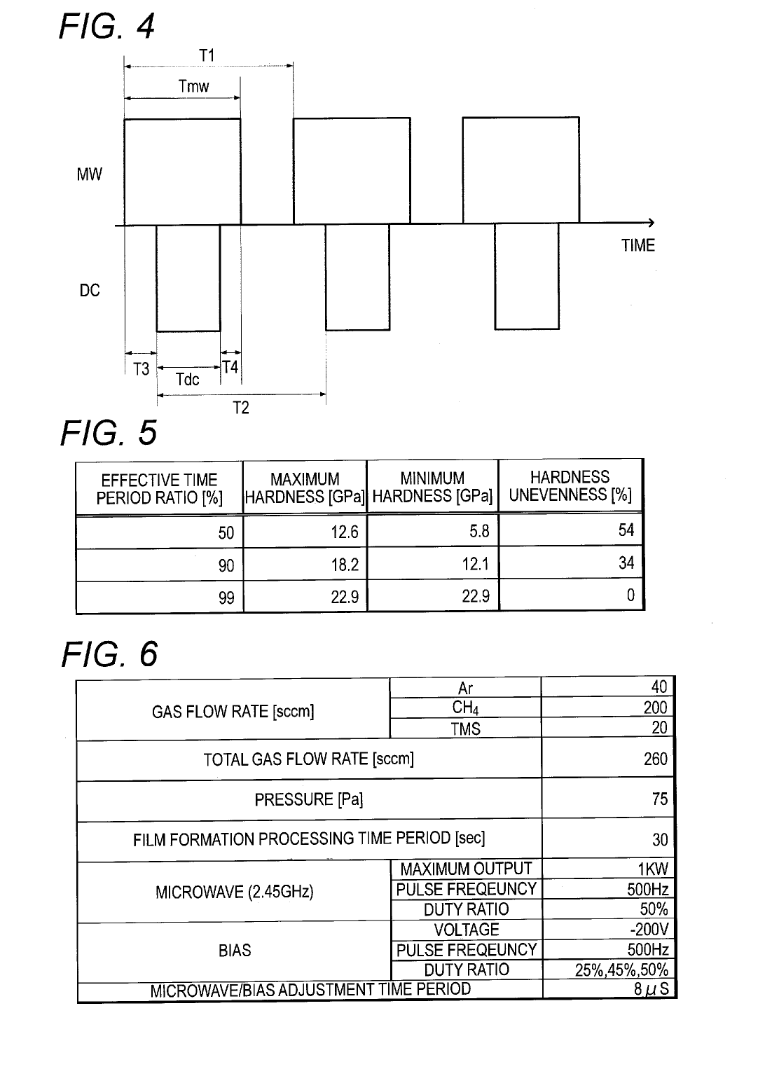

Referring to a pictorial view of pulse waveforms shown in FIG. 4, the ratio of the applying time period of one negative bias voltage pulse in the supplying time period of one microwave pulse to the supplying time period of one microwave pulse is described.

A supplying time period Tmw of microwave pulse for each pulse is expressed with a following equation (1) by a period T1 of the microwave pulse and a microwave pulse a duty ratio DMW (Duty of Microwave). In the meantime, the supplying time period Tmw corresponds to the supplying time period of one microwave pulse.

Tmw=T1*DMW (1)

An applying time period Tdc of the negative bias voltage pulse for each pulse is expressed with a following equation (2) by a period T2 of the negative bias voltage pulse and a negative bias voltage pulse duty ratio DSH (duty of sheath). In the meantime, the applying time period Tdc corresponds to the applying time period of one negative bias voltage pulse.

Tdc=T2*DSH (2)

The ratio of the applying time period is expressed by the supplying time period of one microwave pulse and the applying time period of one negative bias voltage pulse. That is, the ratio of the applying time period is expressed with a following equation (3) by a pulse width Tmw of the microwave, a time period T3 and a time period T4. The time period T3 is a time period from when one microwave pulse is supplied to when the applying of one negative bias voltage pulse starts. In other words, the time period T3 is a time period from when the microwave pulse rises to when the negative bias voltage pulse rises. The time period T4 is a time period from when the supplying of the negative bias voltage pulse is over to when the supplying of the microwave pulse is over. In other words, the time period T4 is a time period from when the negative bias voltage pulse fails to when the microwave pulse fails.

(Tmw−T3−T4)/Tmw (3)

In addition to the pulse waveforms shown in FIG. 4, in a case where the negative bias voltage pulse is applied before the microwave pulse is supplied, the time period T3 is zero. Meanwhile, when the supplying of the microwave pulse is over before the applying of the negative bias voltage pulse is over, the time period T4 is zero. Even when the supplying of the microwave pulse is over before the applying of the negative bias voltage pulse is over, since the film formation speed of the plasma by the negative bias voltage pulses is slower by 1/10 to 1/100, as compared to the MVP method, an effect of reducing the spread of the hardness distribution or the hardness lowering is small. Therefore, in the below, the description is made while considering the time period T4 as zero.

When only the microwave pulses are supplied into the processing vessel 1, the plasma is generated at a side of the workpiece material M facing the jig 5. However, when only the negative bias voltage pulses of a low voltage such as −200V are applied to the workpiece material M, the plasma is not generated. When only the negative bias voltage pulses of a high voltage such as −400V or higher are applied to the workpiece material M, the plasma can be generated. However, since the film formation speed of the plasma by the negative bias voltage pulses is slower by 1/10 to 1/100, as compared to the MVP method, the effect of reducing the spread of the hardness distribution or the hardness lowering is small. That is, the time period for which the negative bias voltage pulses are applied in the time period for which the microwave pulses are supplied into the processing vessel 1 is the ratio of the applying time period of the negative bias voltage pulses in the supplying time period of one microwave pulse to the supplying time period of one microwave pulse. Therefore, in the below, the description is made while considering the ratio of the applying time period as the effective time period ratio.

As shown in FIG. 1, when the microwaves are supplied from one end of the workpiece material M having conductivity and the negative bias voltage pulses are applied from the other end thereof, a hardness distribution of the DLC film about the microwave transmitting window 10 occurs. According to experiments, since the hardness of the DLC film formed in the vicinity of the jig 5 is low and the hardness of the DLC film formed at a position distant from the jig 5 is high, the workpiece material M having a rod shape as shown in FIG. 1 has a hardness distribution with respect to the film formation position in a Z axis direction. The minimum hardness in this case is hardness of the DLC film at a position close to the jig 5 in the Z axis direction shown in FIG. 1. The maximum hardness in this case is hardness of the DLC film at a position close to an opposite side to the jig 5 in the Z axis direction shown in FIG. 1.

A unevenness in the hardness is a value that is obtained by dividing a value, which is obtained by subtracting the minimum hardness from the maximum hardness, by the maximum hardness.

That is, the hardness unevenness indicates a magnitude of the hardness distribution. The effective time period ratio and the hardness unevenness are indicated by percentages. In the below, an experiment result showing the occurrence of the hardness unevenness in the Z axis direction by the effective time period ratio is described. In this illustrative embodiment, the Z axis direction is a longitudinal direction of the workpiece material M.

<Experiment Result of Film Hardness in Case where DLC Film Formation Processing is Performed with Effective Time Period Ratio>

FIG. 5 shows an experiment result showing the hardness of the workpiece material M having conductivity measured in case where the effective time period ratio was set to 50%, 90% and 99%. FIG. 6 is a table showing film formation conditions. As shown in FIG. 6, Ar of 40 sccm as an inert gas, CH₄ of 200 sccm and TMS of 20 sccm as a source gas were supplied to the processing vessel 1. That is, the gases of 260 sccm were supplied to the processing vessel 1. The pressure in the processing vessel 1 was controlled to 75 Pa, and the film formation time period was set to 30 seconds. With respect to the frequency of the microwaves of 2.45 GHz, the power was set to 1 kW, the pulse frequency of the microwave pulses was set to 500 Hz, and the duty ratio of the microwave pulses was set to 50%. For the negative bias voltage pulses, the voltage was set to −200V, the pulse frequency of the negative bias voltage pulses was set to 500 Hz, and the duty ratio of the negative bias voltage pulses was set to 25%, 45% and 50%. The supplying timing of the microwave pulses and the applying timing of the negative bias voltage pulses were set so that the microwave pulses preceded by 8 microseconds. A deviation of the timings is the time period T3 shown in FIG. 4. By the setting of the three duty ratios of the negative bias voltage pulses, the effective time period ratio was set to 50%, 90% and 99%.

As shown in FIG. 5, when the effective time period ratio was set to 99%, the maximum hardness value was larger, as compared to the effective time period ratios of 50% and 90%, so that the hardness unevenness was suppressed. In the below, the experiment result will be described in detail. When the effective time period ratio was set to 50%, the maximum hardness was 12.6 GPa and the minimum hardness was 5.8 GPa. As a result, 54% of the hardness unevenness is caused. When the effective time period ratio was set to 90%, the maximum hardness was 18.2 GPa and the minimum hardness was 12.1 GPa. As a result, 34% of the hardness unevenness is caused. When the effective time period ratio was set to 99%, the maximum hardness was 22.9 GPa and the minimum hardness was 22.9 GPa. As a result, the hardness unevenness is not caused. Therefore, in order to reduce the hardness unevenness, the control unit 4 is preferably configured to instruct the microwave pulse controller 7 and the negative voltage pulse controller 9 to apply the microwave pulses and the negative bias voltage pulses to the processing vessel 1 and the workpiece material M at the same time. In the control table shown in FIG. 3, the values of the maximum hardness, the minimum hardness and the hardness unevenness for each effective time period ratio, which are calculated by approximating the above experiment results, are stored. According to the control table, in order to suppress the hardness unevenness to 35% or less, it is preferably set the effective time period ratio to 90% or higher. In general, if the hardness unevenness is 35% or less, considering a deviation of measurements, it is regarded that there is no problem when the DLC film is formed on the workpiece material M. In particular, when the effective time period ratio is set to 99% or greater, it is possible to remove the hardness distribution of the DLC film formed on the workpiece material M.

The plasma generation method disclosed in Japanese Patent Application Publication No. 2004-47207A does not disclose the supplying timing of the microwaves, the applying timing of the negative bias voltage and the duties thereof. However, when forming a film on a metal-based material and the like, which is the workpiece material, it is necessary to pulse the negative bias voltage so as to reduce a damage of the workpiece material, which is caused due to the arcing. In general, it is known that when forming a film at a state where the negative bias voltage is not applied, a DLC film having low hardness is formed. Further, when the negative bias voltage is not applied, since a sheath layer is not spread to such a thickness that the microwaves can be propagated as surface waves along the processing surface of the workpiece material, the plasma is generated only in the vicinity of the jig 5. For this reason, it is thought that as the plasma generation time period only by the microwaves becomes longer, i.e., as a time period for which the negative bias voltage is not applied in the supplying time period of one microwave pulse becomes longer, the thicker DLC film having lower hardness is deposited on the surface of the workpiece material M in the vicinity of the jig 5. Therefore, according to the plasma generation method in which only the microwaves are supplied, the film thickness becomes uneven in the Z axis direction shown in FIG. 1 and it is not possible to avoid the formation of the DLC film having low hardness.

If a countermeasure against the arching, for example, a configuration of intermittently applying the positive bias voltage pulses is adopted, only the negative bias voltage pulses are applied in a time period for which the microwave pulses are not supplied, so that the plasma, even though it is generated, does not influence the hardness unevenness. For this reason, the negative bias voltage pulses may be increased to a value at which the plasma is generated only by the negative bias voltage pulses. However, comparing the film formation time periods of the film formation using only the negative bias voltage pulses and the film formation using the MVP method, the film is formed at higher speed in the MVP method. For this reason, even when the negative bias voltage pulses are applied in the time period for which the microwave pulses are not supplied, the plasma is generated by the negative bias voltage pulses and a film is thus formed, since most of the DLC film thickness is formed by the MVP method, the effect of reducing the film formation time period only by the applying of the negative bias voltage pulses is small. For this reason, it is preferably not to apply the negative bias voltage pulses in the time period for which the microwave pulses are not supplied, because it is possible to save the energy for the DLC film formation processing.

In the meantime, it is known that when the negative bias voltage pulses are applied after the microwave pulses are supplied, the sheath layer is spread along the processing surface of the workpiece material and the film has the higher hardness than the hardness of the DLC film formed only by the microwaves. That is, the surface of the workpiece material M in the vicinity of the jig 5 is formed with the DLC film of high hardness on the DLC film of low hardness. Therefore, it is not possible to avoid the hardness unevenness of the DLC film in the Z axis direction shown in FIG. 1.

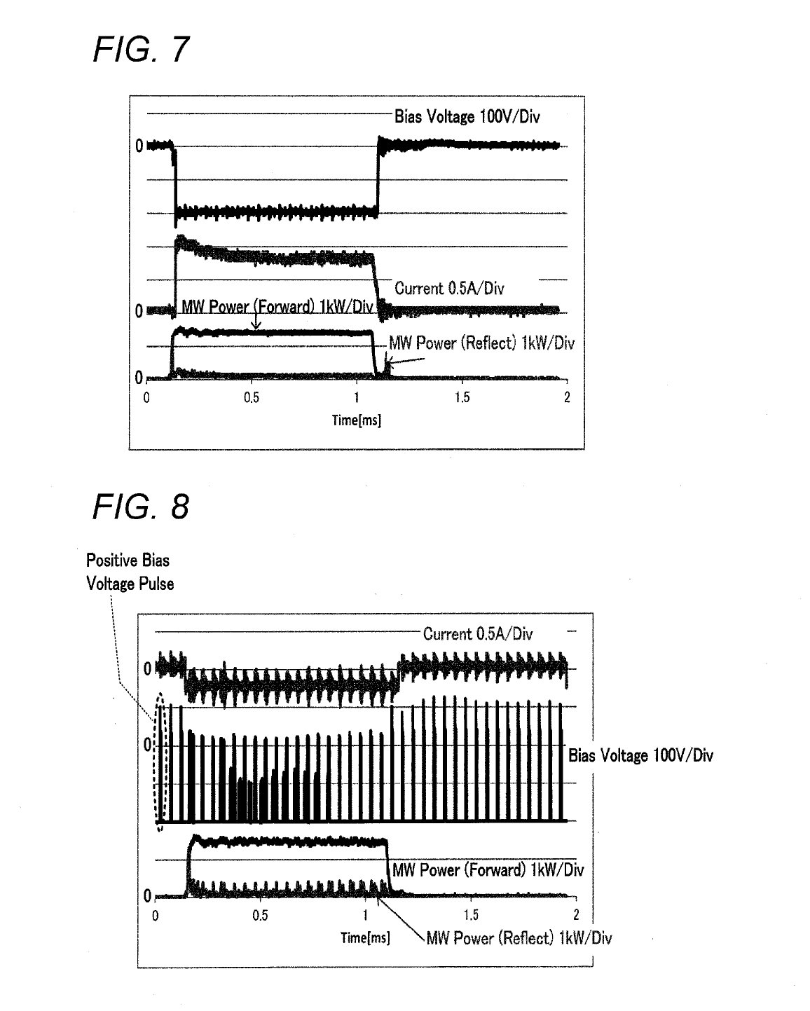

In FIGS. 7 and 8, the time period for which the microwave pulses are applied is indicated by the black solid line denoted with MW Power (Forward) 1 kW/Div. The time period for which the negative bias voltage pulses are applied is indicated by the black solid line denoted with Bias Voltage 100 V/Div. In FIG. 7, the negative bias voltage pulses are applied after supplying of the microwave pulses. The reason is that the rising of the microwave pulses is unstable. The control unit 4 is configured to instruct the microwave pulse controller 7 and the negative voltage pulse controller 9 to apply the microwave pulses and the negative bias voltage pulses to the processing vessel 1 and the workpiece material M having conductivity at the same time without the unstable time period. The unstable time period is about 8 microseconds. That is, the control unit 4 is configured to control the applying timing of the negative bias voltage pulses and the supplying timing of the microwave pulses so that the supplying of one microwave pulse starts before the applying of one negative bias voltage pulse starts. In other words, the control unit 4 controls so that each microwave pulse rises at several microseconds before each negative bias voltage pulse rises.

In FIG. 8, the negative bias voltage pulses are continuously applied during the film formation time period. The positive bias voltage pulses are applied at predetermined timings, so that the effect of suppressing the arcing is obtained. The positive bias voltage pulse is a pulse of which an absolute value is larger than zero (0), and the applying time period thereof is shorter than the applying time period of the negative bias voltage pulse. As denoted with Positive Bias Voltage Pulse shown with the dotted line in FIG. 8, the plurality of positive bias voltage pulses is integrated with the negative bias voltage pulses and is included in Bias Voltage 100 V/Div. A duty ratio of the positive bias voltage pulse is preferably 10% or less of the duty ratio of the negative bias voltage pulse. In this case, the duty ratio parameter is a value obtained by dividing a time period, which is obtained by subtracting the applying time period of the positive bias voltage pulse from the applying time period of the negative bias voltage pulse, by the supplying time period of the microwave pulse. As shown in FIG. 8, the positive bias voltage pulses are applied, so that the hardness unevenness is suppressed. However, the film hardness is 11.7 GPa, which is lower, as compared to the application state shown in FIG. 7. As a result, when increasing the maximum, the control unit 4 preferably performs the control so that only the microwave pulses and negative bias voltage pulses are applied.

<Film Formation Processing>

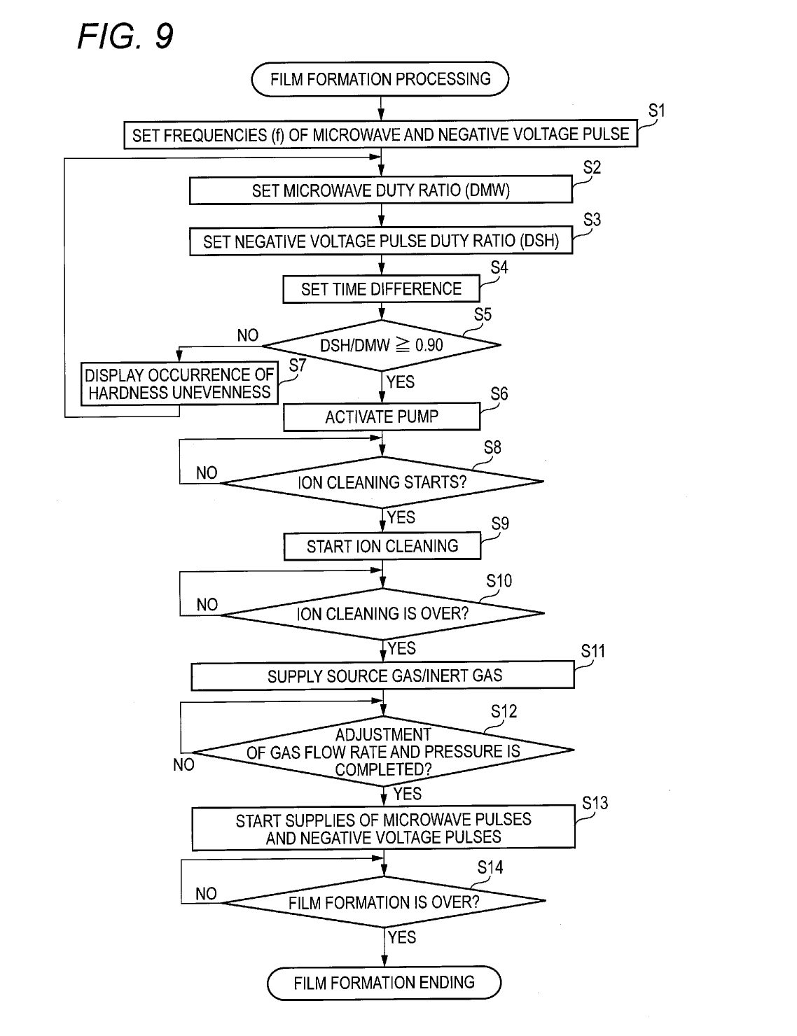

The film formation processing is described with reference to a flowchart shown in FIG. 9. When the CPU 20 detects that an operator inputs an instruction of starting the film formation processing into the film forming device 100 at a state where the workpiece material M held at the jig 5 is set in the processing vessel 1, the film formation processing is executed. The processing shown in the flowchart of FIG. 9 is executed by the CPU 20.

In S1, the frequencies of the microwave pulse and negative bias voltage pulse are set. In the experiment shown in FIG. 5, the frequencies are set to 500 Hz. The setting may be manually made by the operator, or the frequencies of the microwave pulse and negative bias voltage pulse may be beforehand stored in the storage unit 21 and may be automatically set. When the frequencies are set, the processing proceeds to S2.

In S2, the microwave pulse duty ratio DMW is set. In the experiment shown in FIG. 5, the duty ratio is set to 50%. The setting may be manually made by the operator, or the microwave pulse duty ratio may be beforehand stored in the storage unit 21 and may be automatically set. When the microwave pulse duty ratio is set, the processing proceeds to S3. In this illustrative embodiment, the period T1 of the microwave pulse is beforehand stored in the storage unit 21, and the stored period T1 is set as the period of the microwave pulse. However, the operator may set the period T1 of the microwave pulse in S2.

In S3, the negative bias voltage pulse duty ratio DSH is set. In the experiment shown in FIG. 5, the duty ratio is set to any one of 25%, 45% and 50%. The setting may be manually made by the operator, or the negative bias voltage pulse duty ratio may be beforehand stored in the storage unit 21 and may be automatically set. When the negative bias voltage pulse duty ratio is set, the processing proceeds to S4. In this illustrative embodiment, the period T2 of the negative bias voltage pulse is beforehand stored in the storage unit 21, and the stored period T2 is set as the period of the negative bias voltage pulse. However, the operator may set the period T2 of the negative bias voltage pulse in S3.

In S4, a time difference of the timings between the microwave pulse supplying and the negative bias voltage pulse applying is set. In the experiment shown in FIG. 5, the time difference is set to 8 microseconds. The time difference is the time period T3 shown in FIG. 4. When the time difference of the timings is set, the processing proceeds to S5. Also, the time period T4 shown in FIG. 4 may be set in S4, although it is not set in this illustrative embodiment.

In S5, following determinations are made based on the microwave pulse duty ratio DMW and the negative bias voltage pulse duty ratio DSH set in S2 and S3 and the time difference of the timings between the microwave pulse supplying and the negative bias voltage pulse applying set in S4. It is determined whether the effective time period ratio (DSH/DMW) is equal to or greater than 0.9. When it is determined that the effective time period ratio is equal to or greater than 0.9, the processing proceeds to S6. When it is determined that the effective time period ratio is less than 0.9, the processing proceeds to S7. When the microwave pulse duty ratio DMW is set to 50% in S2 and the negative bias voltage pulse duty ratio DSH is set to 50% in S3, it is determined that the effective time period ratio is equal to or greater than 0.9 based on the time difference of the timings.

When it is determined in S5 that the effective time period ratio is less than 0.9, the negative bias voltage pulse duty ratio or microwave pulse duty ratio and the time difference of the timings between the microwave pulse supplying and the negative bias voltage pulse applying may be automatically set so that the effective time period ratio is equal to or greater than 0.9.

In S6, predetermined parameters are set and the vacuum pump 2 is activated. When the vacuum pump 2 is activated, the processing proceeds to S8. The predetermined parameters include ion cleaning parameters and parameters of a gas flow rate value, a film formation time period, a voltage value instructed to the negative voltage power source 8, a pulse signal instructed to the microwave pulse controller 7 and the like. The parameters may be manually set by the operator or may be automatically set based on the parameters beforehand stored in the storage unit 21. The ion cleaning parameters are parameters relating to ion cleaning processing that will be described later.

In S7, a notification indicating that the hardness unevenness occurs is displayed on a display (not shown). When the notification is displayed on the display, the processing proceeds to S2. Also, in S5, when it is determined that the effective time period ratio is less than 0.9, a notification indicating that the hardness unevenness occurs may be displayed on the display. In case where the operator selects to accept occasion of the hardness unevenness after displaying the notification, the processing may proceed to S6.

In S8, it is determined whether to start the ion cleaning. In the determination, it is determined whether a degree of vacuum in the processing vessel 1 is less than 1.0 Pa. The determination is performed based on the degree of vacuum measured by a vacuum gauge (not shown). When it is determined that the degree of vacuum is less than 1.0 Pa, the ion cleaning starts and the processing proceeds to S9. When it is determined that the degree of vacuum is equal to or greater than 1.0 Pa, the processing returns to S8. In this illustrative embodiment, the degree of vacuum is determined based on 1.0 Pa. However, this disclosure is not limited to 1.0 Pa. For example, 3.0 Pa or 0.1 Pa may be adopted. When it is determined that the ion cleaning starts, the processing proceeds to S9.

In S9, the ion cleaning starts. The ion cleaning is performed based on the ion cleaning parameters set in S6. The ion cleaning parameters include parameters, for example, the flow rate value of the inert gas, the voltage value instructed to the negative voltage power source 8, the negative bias voltage pulse duty ratio instructed to the negative voltage pulse controller 9 and the microwave pulse duty ratio instructed to the microwave pulse controller 7. Based on the flow rate of the inert gas, the gas supplying unit 3 is enabled to supply the inert gas to the processing vessel 1. Then, the control unit 4 transmits the voltage value of the negative bias voltage pulses to the negative voltage power source 8. The control unit 4 transmits the information of the microwave pulse duty ratio and the information of the microwave power to the microwave pulse controller 7. The control unit 4 transmits the information of the negative bias voltage pulse duty ratio to the negative voltage pulse controller 9. As a result, the negative voltage power source 8 supplies the negative voltage to the negative voltage pulse controller 9, in response to the received voltage value. The negative voltage pulse controller 9 applies the negative bias voltage pulses to the workpiece material M from the supplied negative bias voltage and information of the duty ratio. The microwave pulse controller 7 transmits the pulse signal depending on the received information of the microwave pulse duty ratio and information of the microwave pulse power to the microwave power source 6. The microwave power source 6 supplies the microwave pulses depending on the received pulse signal to the surface of the workpiece material M through the microwave transmitting window 10. Thereby, the plasma is generated by the negative bias voltage pulses and the microwave pulses. By the generated plasma, the surface of the workpiece material M is ion-cleaned, and the DLC film, which is described later, is likely to form. When the ion cleaning starts, the processing proceeds to S10.

In S10, it is determined whether or not to end the ion cleaning. The determination is made by determining whether an arcing occurrence frequency is less than a predetermined frequency. Data indicating the predetermined frequency is beforehand stored in the storage unit 21. When it is determined that an arcing occurrence frequency is less than the predetermined frequency, the processing proceeds to S11. When it is determined that an arcing occurrence frequency is equal to or greater than the predetermined frequency, the processing returns to S10. The ending determination may be made by determining whether an ion cleaning time period set as the ion cleaning parameter has elapsed.

In S11, a flow rate control instruction for supplying the inert gas and the source gas is output to the gas supplying unit 3. The flow rate control instruction is based on the gas flow rate value set in S6. The gas supplying unit 3 supplies the inert gas and the source gas into the processing vessel 1, in response to the flow rate control instruction. When the flow rate control instruction is output, the processing proceeds to S12.

In S12, it is determined whether adjustment of the gas flow rate and pressure is completed. The determination is made based on standards of the inert gas flow rate, the active gas flow rate and the pressure of the processing vessel 1. The standards of the inert gas flow rate, the active gas flow rate and the pressure of the processing vessel 1 are beforehand stored in the storage unit 21. When it is determined that the adjustment is completed, the processing proceeds to S13. When it is determined that the adjustment is not completed, the processing returns to S12.

In S13, the plasma is generated and the DLC film formation processing of the workpiece material M starts. Specifically, the negative voltage value set as the predetermined parameter in S6 is transmitted to the negative voltage power source 8, and the microwave power value is transmitted to the microwave pulse controller 7. In the experiment shown in FIG. 5, the negative voltage value was −200V and the microwave power value was 1 kW. The control unit 4 transmits the information of the respective duty ratios determined in S5 to the microwave pulse controller 7 and the negative voltage pulse controller 9. The information of the respective duty ratios includes the period T1, the period T2 and the time period T3, too. In the experiment shown in FIG. 5, the microwave pulse duty ratio was set to 50%. The negative bias voltage pulse was set any one of 25%, 45% and 50%. The negative voltage power source 8 supplies the negative voltage to the negative voltage pulse controller 9 in accordance with the received negative voltage information. The negative voltage pulse controller 9 applies the negative bias voltage pulses to the workpiece material M from the supplied negative voltage and information of the negative bias voltage pulse duty ratio. The microwave pulse controller 7 transmits the pulse signal, depending on the received microwave pulse duty ratio information and the information of the microwave power, to the microwave power source 6. The microwave power source 6 supplies the microwave pulses depending on the received pulse signal to the surface of the workpiece material M through the microwave transmitting window 10.

When the microwave pulses are supplied to the processing surface of the workpiece material M, the plasma is generated by the negative bias voltage pulses and the microwave pulses. The microwave pulses and negative bias voltage pulses depending on the respective pulse duty ratios are supplied and applied from the microwave power source 6 and the negative voltage pulse controller 9 for the film formation time period set in S6, so that the plasma is continuously generated.

In the below, the microwave pulses and the negative bias voltage pulses at the start of the film formation in S13 are described in detail. At the start of the film formation, it is not necessarily required to perform the film formation processing from the beginning so that the ratio of the applying time period of one negative bias voltage pulse in the supplying time period of one microwave pulse to the supplying time period of one microwave pulse is equal to or greater than 0.9. That is, in order to easily adjust the impedance matching, only the microwave pulses may be precedently supplied.

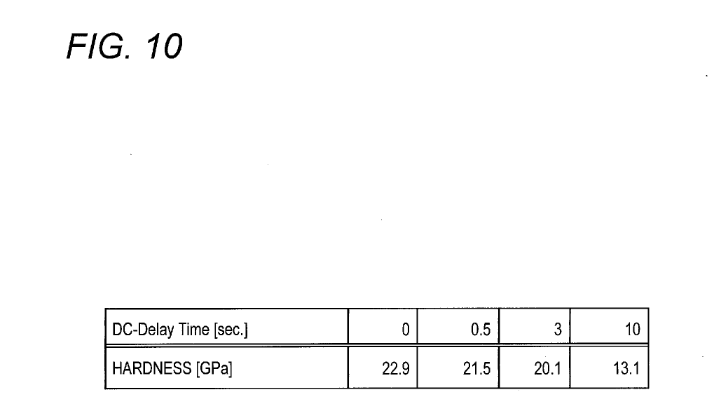

FIG. 10 shows an experiment result indicating a change in hardness of the DLC film over time (DC-Delay Time) from when the microwave pulses are precedently supplied to when the negative bias voltage pulses are applied. As shown in FIG. 10, as the time period from when the microwave pulses are supplied to when the negative bias voltage pulses are applied is prolonged, the film hardness of the DLC film is decreased. That is, as the time period T3 for which the negative bias voltage pulses are first applied in S13 is prolonged, the film hardness of the DLC film is decreased. In particular, in case where a time period from when the microwave pulses are supplied to when the negative bias voltage pulses are applied is 3 second or more, the film hardness of the DLC film becomes 20 GPa or less. According to the experiment result, in order to increase the film hardness of the DLC film to 20 GPa or greater, the negative bias voltage pulses should be applied within 3 seconds after the microwave pulses are supplied. The microwave pulse first supplied to the film forming device 100 after the power is fed is at an unstable state where, for example, a reflected wave becomes greater due to an influence such as an impedance mismatching, at an early stage at which the microwave pulse is supplied into the processing vessel 1. At the unstable state, the control unit 4 may automatically adjust the parameters such as impedance to supply a desired microwave pulse to the processing vessel 1. Alternatively, the parameters may be manually set by the operator. The desired microwave pulse is determined by determining whether reflected power of the output microwave pulse is equal to or less than a predetermined value. When the control time period exceeds 3 seconds, it is not possible to increase the film hardness of the DLC film to 20 GPa or greater. As a result, if there is a case where the control time period will exceed 3 seconds, when executing the DLC film formation processing for the first time after the power is fed to the film forming device 100, it would be required to set an unnecessary workpiece material in the film forming device 100 and to supply the microwave pulse, thereby adjusting the microwave pulse impedance.

In S14, it is determined whether or not to end the film formation. The determination is made by determining whether the film formation time period set in S6 has elapsed. When it is determined that the set film formation time period has elapsed, the film formation processing is finished. When it is determined that the set film formation time period has not elapsed, the processing returns to S14. In the meantime, the determination may be made by determining whether the DLC film reaches a desired film thickness by a film thickness measuring device (not shown).

### Modified Embodiment 1

In the above illustrative embodiment, the workpiece material M is held by the jig 5. However, the workpiece material may be directly supported to the microwave transmitting window 10.

According to this disclosure, the control unit, the control step or the timing control step is to control the applying timing of the negative bias voltage pulses and the supplying timing of the microwave pulses so that the ratio of the applying time period of one negative bias voltage pulse in the supplying time period of one microwave pulse to the supplying time period of one microwave pulse is equal to or greater than 0.9. As a result, it is possible to suppress a hardness distribution of a DLC film formed on the workpiece material within 35% or less.

According to this disclosure, the control unit is configured to control the applying timing of the negative bias voltage pulses and the supplying timing of the microwave pulses so that each microwave pulse is supplied before each negative bias voltage pulse is applied. In general, when the microwave pulses are supplied, there occurs a time period in which an output of the microwave pulses is unstable, just after each microwave pulse rises, and then the output becomes stable. Although the unstable time period is different depending on characteristics of a power source, it is usually several microseconds. When the negative bias voltage pulses are applied at a state where the output of the microwave pulses is unstable, the unstable time period is prolonged or the arching may occur, thereby influencing a quality of the formed film. For this reason, the control is preferably performed so that each microwave pulse is supplied, the output of the microwave pulses is stable and then each negative bias voltage pulse is applied.

According to this disclosure, the control unit is configured to control the applying timing of the negative bias voltage pulses and the supplying timing of the microwave pulses so that the ratio of an applying time period of one negative bias voltage pulse in the supplying time period of one microwave pulse to the supplying time period of one microwave pulse is equal to or greater than 0.99. As a result, it is possible to remove the hardness distribution of the DLC film formed on the workpiece material.

According to this disclosure, the control unit is configured to further control the applying timing so that the negative bias voltage pulses, which are applied by the application unit, are applied within 3 seconds after the microwave pulses are supplied by the microwave supplying unit, when starting a film formation. In general, in plasma film formation processing using the microwaves, a time period for performing a tuning by a three stub tuner and the like is required. When it takes time to perform the tuning of the microwaves, the hardness is lowered as much as that. In contrast, when the applying timing is controlled so that the negative bias voltage pulses, which are first applied by the application unit, are applied within 3 seconds after the microwave pulses are applied by the microwave supplying unit, it is possible to avoid that the hardness is lowered below 20 GPa.

According to this disclosure, the microwave supplying unit is configured to supply the microwave pulses from one end of the workpiece material supported in the processing vessel, and the applying unit is configured to apply the negative bias voltage pulses to an entire area of at least the processing surface of the workpiece material. Since the microwaves are supplied from one end of the workpiece material and the negative bias voltage pulses are applied to the entire area of the processing surface, the plasma covers the entire area of the processing surface of the workpiece material. Therefore, it is possible to form the DLC film over the entire area of the processing surface of the workpiece material.

What is claimed is:

1. A film forming device comprising:
a gas supplying unit configured to supply a source gas having carbon and hydrogen and an inert gas to a processing vessel provided with a workpiece material having conductivity;
a microwave supplying unit configured to supply microwave pulses to generate plasma along a processing surface of the workpiece material;
an applying unit configured to apply negative bias voltage pulses to the workpiece material in the processing vessel to spread a sheath layer along the processing surface of the workpiece material, and
a control unit configured to control an applying timing of the negative bias voltage pulses of the applying unit and a supplying timing of the microwave pulses of the microwave supplying unit,
wherein the control unit is configured to control the applying timing of the negative bias voltage pulses and the supplying timing of the microwave pulses so that a ratio of an applying time period of one negative bias voltage pulse in a supplying time period of one microwave pulse to the supplying time period of one microwave pulse is equal to or greater than 0.9.

2. The film forming device according to claim 1,
wherein the control unit sets a duty ratio of the microwave pulse and a duty ratio of the negative bias voltage pulse,
wherein the control unit sets a timing difference between the applying timing of the negative bias voltage pulses and the supplying timing of the microwave pulses.

3. The film forming device according to claim 1,
wherein the control unit is configured to control:
the microwave supplying unit based on a period of the microwave pulse and a duty ratio of the microwave pulse; and
the applying unit based on a period of the negative bias voltage pulse and a duty ratio of the negative bias voltage pulse.

4. The film forming device according to claim 1,
wherein the control unit sets:
a start timing period, which is a time period from when one microwave pulse is supplied to when the applying of one negative bias voltage pulse starts; and
a stop timing period, which is a time period from when the supplying of the negative bias voltage pulse is over to when the supplying of the microwave pulse is over,
wherein the control unit sets the ratio, based on the supplying time period of one microwave pulse, the start timing period, and the stop timing period.

5. The film forming device according to claim 1,
wherein the control unit is configured to control the applying timing of the negative bias voltage pulses and the supplying timing of the microwave pulses so that each microwave pulse is supplied before each negative bias voltage pulse is applied.

6. The film forming device according to claim 1,
wherein the control unit is configured to control the applying timing of the negative bias voltage pulses and the supplying timing of the microwave pulses so that the ratio of an applying time period of one negative bias voltage pulse in the supplying time period of one microwave pulse to the supplying time period of one microwave pulse is equal to or greater than 0.99.

7. The film forming device according to claim 1,
wherein, in starting a film formation, the control unit is configured to further control, the applying timing so that the negative bias voltage pulses applied by the application unit are applied within 3 seconds after the microwave pulses are supplied by the microwave supplying unit.

8. The film forming device according to claim 1,
wherein the microwave supplying unit is configured to supply the microwave pulses from one end of the workpiece material in the processing vessel, and
wherein the applying unit is configured to apply the negative bias voltage pulses to an entire area of at least the processing surface of the workpiece material.

9. A film forming method comprising:
supplying a source gas having carbon and hydrogen and an inert gas to a processing vessel provided with a workpiece material having conductivity;
supplying microwave pulses to generate plasma along a processing surface of the workpiece material;
applying negative bias voltage pulses to the workpiece material in the processing vessel to spread a sheath layer along the processing surface of the workpiece material, and
controlling an applying timing of the negative bias voltage pulses and a supplying timing of the microwave pulses,
wherein the controlling controls the applying timing of the negative bias voltage pulses and the supplying timing of the microwave pulses so that a ratio of an applying time period of one negative bias voltage pulse in a supplying time period of one microwave pulse to the supplying time period of one microwave pulse is equal to or greater than 0.9.

10. A non-transitory computer-readable medium having instructions to control a processer in a film forming device comprising a gas supplying unit configured to supply a source gas having carbon and hydrogen and an inert gas to a processing vessel provided with a workpiece material having conductivity; a microwave supplying unit configured to supply microwave pulses to generate plasma along a processing surface of the workpiece material, and an applying unit configured to apply negative bias voltage pulses to spread a sheath layer along the processing surface of the workpiece material to the workpiece material supported in the processing vessel, the processer, when executing the instructions, causing the film forming device to execute:
controlling an applying timing of one negative bias voltage pulse of the applying unit and a supplying timing of one microwave pulse of the microwave supplying unit,
wherein the computer controls the applying timing of the negative bias voltage pulses and the supplying timing of the microwave pulses so that a ratio of an applying time period of one negative bias voltage pulse in a supplying time period of one microwave pulse to the supplying time period of one microwave pulse is equal to or greater than 0.9.
